(19) United States
(12) Patent Application Publication
(10) Pub. No.: US 2026/0246330 A1
(43) Pub. Date: Aug. 20, 2026

(54) ELECTRIC PUMP

(71) Applicant: MIKUNI CORPORATION, Tokyo (JP)

(72) Inventors: Kousuke YAMADA, Odawara-shi (JP); Osamu ENDO, Odawara-shi (JP); Hiroshi KOIWA, Odawara-shi (JP)

(21) Appl. No.: 19/407,355

(22) Filed: Dec. 3, 2025

(30) Foreign Application Priority Data
Feb. 17, 2025 (JP) 2025-022981

(51) Int. Cl. H02K 5/10; H02K 1/2706; H02K 1/2786; H02K 1/28; H02K 7/14; H02K 9/22

(52) U.S. Cl. CPC H02K 5/10; H02K 1/2706; H02K 1/2786; H02K 1/28; H02K 7/14; H02K 9/227; H02K 2203/03

(57) ABSTRACT

An electric pump is provided with: a support part; a rotor that includes an impeller and a magnet and is rotatably supported by the support part; a stator that includes a stator core, a stator coil, and a molding material covering the stator core and the stator coil; a control board for controlling electricity to be supplied to the stator coil; and a casing that includes a partition part separating a pump motor chamber from a board chamber. The partition part of the casing is formed as part of the molding material by integral molding with the stator core, the stator coil, and the support part as insert parts, and has one or more openings allowing a fluid from the impeller to pass through. The electric pump or is further provided with a heat sink disposed to close the one or more openings of the partition part.

### TECHNICAL FIELD

The present disclosure relates to an electric pump.

### BACKGROUND

Conventionally, an electric pump with an impeller for boosting fluid pressure and a motor part for rotating the impeller in the same casing has been known. The motor part is controlled by a control board that includes electronic components represented by switching devices such as MOSFETs and IGBTs, and a printed wiring board on which the electronic components are mounted.

In this type of electric pump, the heat dissipation design of the control board is important in terms of controlling the temperature rise of the electronic components.

For example, Patent Document 1 describes a water pump with an inner rotor motor in which the rotor is disposed radially inward of the stator, and a heat sink (heat dissipation member) is provided in contact with liquid flowing in the electric pump to promote heat dissipation from the electronic components.

In the water pump described in Patent Document 1, the heat sink fixed in close contact with a cylindrical portion of the housing part is cooled by contact with liquid flowing in the housing part to promote heat dissipation from the electronic components.

### CITATION LIST

### Patent Literature

Patent Document 1: JP2021-87315A

### SUMMARY

However, in the water pump described in Patent Document 1, during assembly, the heat sink is fixed to the housing part, which is a separate component from the stator, and a shaft is further press-fitted into the heat sink via a bearing, which increases the number of parts and assembly man-hours.

In view of the above, an object of at least some embodiments of the present invention is to provide an electric pump that can reduce the number of parts and assembly man-hours and also promote heat dissipation from the control board.

An electric pump according to at least some embodiments of the present invention is provided with: a support part; a rotor that includes an impeller and a magnet and is rotatably supported by the support part; a stator that includes a stator core disposed with a magnetic gap between the stator core and the magnet, a stator coil wound around the stator core, and a molding material covering the stator core and the stator coil; a control board for controlling electricity to be supplied to the stator coil; and a casing that partially defines a pump motor chamber for accommodating the rotor and the stator and a board chamber for accommodating the control board and includes a partition part separating the pump motor chamber from the board chamber. The partition part of the casing is formed as part of the molding material by integral molding with the stator core, the stator coil, and the support part as insert parts, and has one or more openings allowing a fluid from the impeller to pass through. The electric pump is further provided with a heat sink disposed to close the one or more openings of the partition part.

According to at least some embodiments of the present invention, the fluid passing through the openings in the partition part of the casing, which separates the pump motor chamber from the board chamber, flows toward the heat sink that closes the openings, thus promoting heat dissipation from the control board via the heat sink.

Additionally, since the partition part with the openings for guiding the fluid to the heat sink is formed as part of the molding material by integral molding with the stator core, the stator coil, and the support part as insert parts, the number of parts and assembly man-hours can be reduced.

Therefore, it is possible to reduce the number of parts and assembly man-hours while promoting heat dissipation from the control board.

### BRIEF DESCRIPTION OF DRAWINGS

FIG. 1A is an axial cross-sectional view showing a schematic configuration of an electric pump according to an embodiment.

FIG. 1B is an axial cross-sectional view showing a schematic configuration of an electric pump according to another embodiment.

FIG. 1C is an axial cross-sectional view showing a schematic configuration of an electric pump according to still another embodiment.

FIG. 1D is an axial cross-sectional view showing a schematic configuration of an electric pump according to still another embodiment.

FIG. 1E is an axial cross-sectional view showing a schematic configuration of an electric pump according to still another embodiment.

FIG. 2A is a schematic cross-sectional view showing a structure around a partition part and a heat sink according to an embodiment.

FIG. 2B is a partial cross-sectional view corresponding to FIG. 2A, showing the structure around the partition part and the heat sink.

FIG. 3A is a schematic cross-sectional view showing a structure around a partition part and a heat sink according to another embodiment.

FIG. 3B is a partial cross-sectional view corresponding to FIG. 3A, showing the structure around the partition part and the heat sink.

FIG. 4 is a schematic cross-sectional view showing a structure around a partition part and a heat sink according to still another embodiment.

FIG. 5A is a perspective view showing a structure of a heat sink according to an embodiment.

FIG. 5B is a perspective view showing a structure of a heat sink according to another embodiment.

FIG. 5C is a perspective view showing a structure of a heat sink according to still another embodiment.

### DETAILED DESCRIPTION

Embodiments of the present invention will now be described in detail with reference to the accompanying drawings. It is intended, however, that unless particularly identified, dimensions, materials, shapes, relative positions, and the like of components described in the embodiments shall be interpreted as illustrative only and not intended to limit the scope of the present invention.

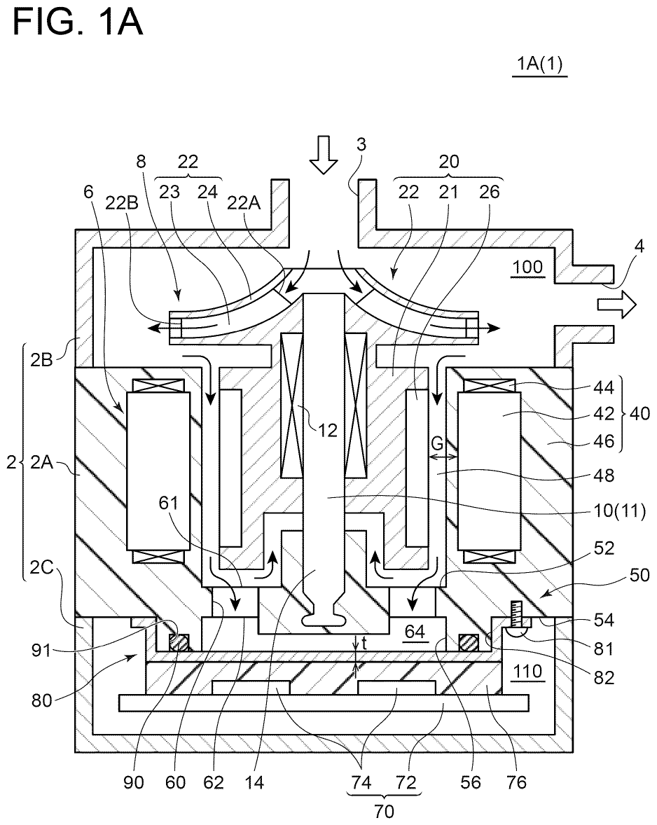

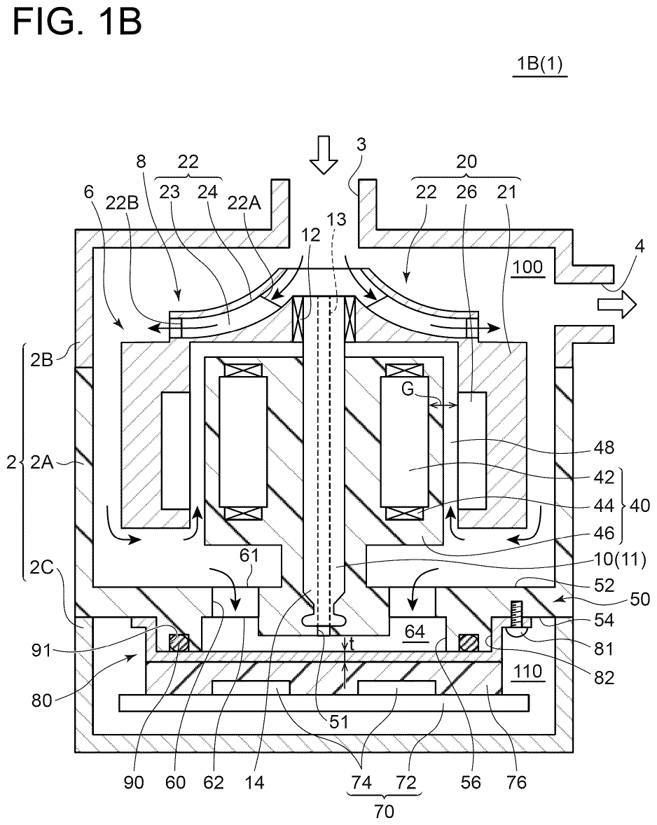

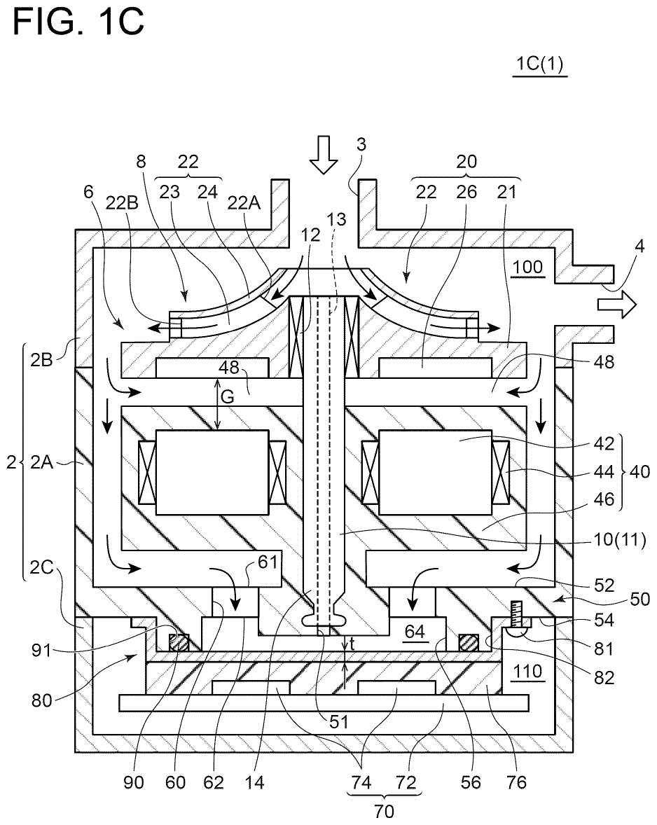

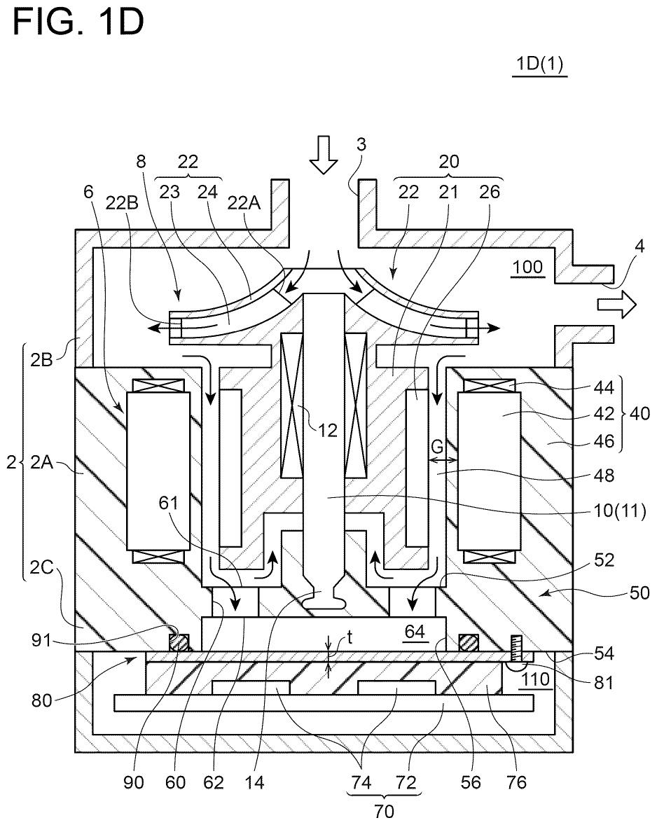

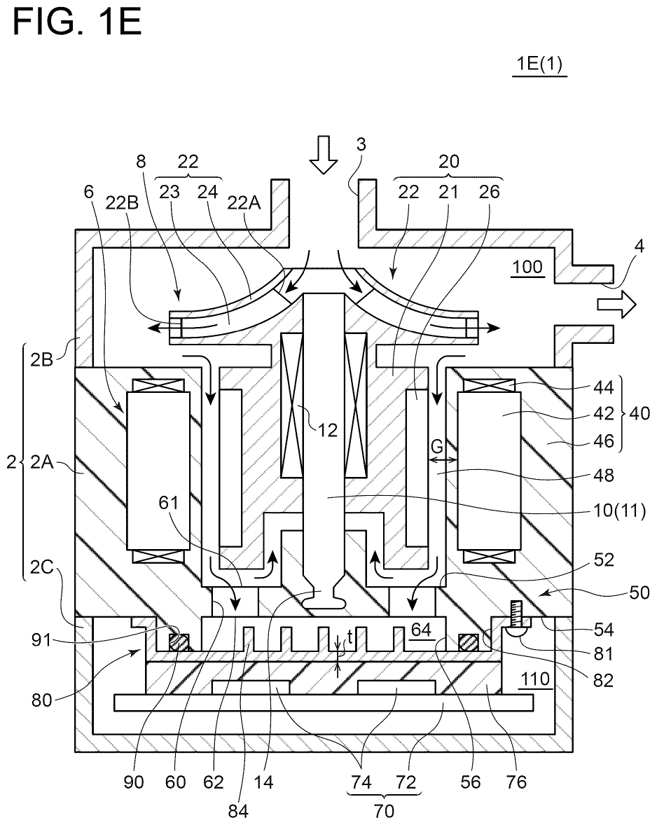

FIG. 1A is an axial cross-sectional view showing a schematic configuration of an electric pump 1A according to an embodiment.

FIG. 1B is an axial cross-sectional view showing a schematic configuration of an electric pump 1B according to another embodiment.

FIG. 1C is an axial cross-sectional view showing a schematic configuration of an electric pump 1C according to still another embodiment.

FIG. 1D is an axial cross-sectional view showing a schematic configuration of an electric pump 1D according to still another embodiment.

FIG. 1E is an axial cross-sectional view showing a schematic configuration of an electric pump 1E according to still another embodiment.

Hereafter, when referring to electric pumps according to some embodiments of the present invention including the electric pumps 1A to 1E, they will be referred to as electric pumps 1 (1A to 1E). Similarly, when referring to electric pumps according to some embodiments including some of the electric pumps 1A to 1E, they will be referred to as, for example, electric pumps 1 (1A, 1C), with the intent of clearly indicating embodiments encompassed.

The electric pumps 1 (1A to 1E) may be water pumps.

The electric pumps 1 (1A, 1D, 1E) according to the embodiments shown in FIGS. 1A, 1D, and 1E are electric pumps of inner rotor type in which the rotor 20 is disposed radially inward of the stator 40. In contrast, the electric pump 1 (1B) according to the embodiment shown in FIG. 1B is an electric pump of outer rotor type in which the rotor 20 is disposed radially outward of the stator 40. The electric pump 1 (1C) according to the embodiment shown in FIG. 1C is an electric pump of axial gap type in which the rotor 20 and the stator 40 face each other in the axial direction.

In some embodiments, as shown in FIGS. 1A to 1E, the electric pump 1 (1A to 1E) includes a casing 2, and a motor part 6 and a pump part 8 which are disposed in a pump motor chamber 100 within the casing 2.

The pump motor chamber 100 is partially defined by a partition part 50 of the casing 2, which will be described below.

The motor part 6 is controlled by a control board 70 which is disposed in a board chamber 110 within the casing 2.

The board chamber 110 is partially defined by the partition part 50 of the casing 2, which will be described below.

The area (pump chamber) of the pump motor chamber 100 where the pump part 8 is disposed communicates with a fluid inlet 3 and a fluid outlet 4. Fluid taken into the pump chamber through the fluid inlet 3 is boosted in pressure as it passes through the impeller 22 of the pump part 8, and is discharged through the fluid outlet 4. In the exemplary embodiments shown in FIGS. 1A to 1E, the fluid is guided in the axial direction through the fluid inlet 3 to the impeller 22, and after passing through the impeller 22, the fluid is discharged through the fluid outlet 4.

In the embodiments shown in FIGS. 1A to 1E, the pump part 8 is a centrifugal pump that uses centrifugal force resulting from the rotation of the impeller 22. Specifically, the pump part 8 is a volute pump with a volute chamber disposed radially outward of the impeller 22.

The pump part 8 may be any other form of centrifugal pump as long as it includes the impeller 22; in other embodiments, the pump part 8 is a turbine pump with guide vanes.

As described above, from a functional viewpoint of the electric pump 1 (1A to 1E), the components of the electric pumps 1 (1A to 1E) can be mainly classified into the motor part 6, which functions as a motor, and the pump part 8, which functions as a pump.

On the other hand, from the viewpoint of physical structure, the electric pump 1 (1A to 1E) can also be classified into several elements. The components of the electric pump 1 (1A to 1E) will be described below.

In some embodiments, as shown in FIGS. 1A to 1E, the electric pump 1 (1A to 1E) includes the above-described casing 2, a support part 10, a rotor 20 as the rotating member, a stator 40 as the stationary member, a control board 70 for controlling the motor part 6, and a heat sink 80 for promoting heat dissipation from the control board 70.

The casing 2 includes an intermediate casing 2A, as well as a pump casing 2B and a board casing 2C located on opposite sides of the intermediate casing 2A in the axial direction.

The intermediate casing 2A is formed by a molding material 46 of the stator 40, which w be described below. The pump casing 2B is attached to one end portion of the intermediate casing 2A in the axial direction of the electric pump 1 (1A to 1E). The intermediate casing 2A and the pump casing 2B define the pump motor chamber 100 as a flow space for accommodating the motor part 6 and the pump part 8. The pump casing 2B covers, together with the intermediate casing 2A, the impeller 22 of the rotor 20, which will be described below. The board casing 2C is attached to the other end portion of the intermediate casing 2A in the axial direction of the electric pump 1 (1A to 1E). The intermediate casing 2A and the board casing 2C define the board chamber 110 for accommodating the control board 70. In other words, the board casing 2C covers the control board 70 together with the intermediate casing 2A.

In the embodiments shown in FIGS. 1A to 1E, the support part 10 is a hollow or solid stationary shaft (fixed shaft) 11 extending along the central axis of the impeller 22. The stationary shaft 11 as the support part 10 extends axially in the pump motor chamber 100. In the case where the support part 10 is the stationary shaft 11, the rotor 20 is rotatably supported by the support part 10 (stationary shaft 11) via a bearing 12.

In other embodiments not shown, the support part 10 may be a bearing that rotatably supports the rotational shaft of the rotor 20 extending along the central axis of the impeller 22 to the casing 2 or the stator 40.

In the exemplary embodiments shown in FIGS. 1A, 1D and 1E, the support part 10 is a solid stationary shaft 11.

In contrast, in the exemplary embodiments shown in FIGS. 1B and 1C, the support part 10 is a hollow stationary shaft 11 with an interior space 13 extending in the axial direction.

The rotor 20 is disposed radially outward of the support part 10 and is rotatably supported by the support part 10. The rotor 20 is disposed in the pump motor chamber 100.

The rotor 20 includes an impeller 22 and a magnet 26, as shown in FIGS. 1A to 1E.

The impeller 22 is arranged facing the fluid inlet 3 of the casing 2 in the axial direction. The magnet 26 is located on the opposite side of the impeller 22 from the fluid inlet 3 in the axial direction (back side of impeller 22).

The impeller 22 of the rotor 20 includes a plurality of blades 23 arranged in the circumferential direction.

An intake port 22A is formed between the leading edges of adjacent blades 23, and a discharge port 22B is formed between the trailing edges of adjacent blades 23. The intake port 22A of the impeller 22 communicates with the fluid inlet 3, and the rotation of the impeller 22 imparts velocity energy to fluid flowing in from the fluid inlet 3. The discharge port 22B of the impeller 22 communicates with the fluid outlet 4. The fluid after passing through the impeller 22 flows radially outward through the discharge port 22B and is discharged from the fluid outlet 4.

The pump motor chamber 100 is filled with the fluid. In other words, every space in the pump motor chamber 100, including a clearance 48 between the rotor 20 and the stator 40, which will be described below, and a bearing clearance of the bearing 12, communicates with the discharge port 22B of the impeller 22, and some of the fluid after passing through the impeller 22 can flow into these clearances. Some of the fluid after passing through the impeller 22 is returned to the intake port 22A of the impeller 22 via the space in the pump motor chamber 100 including the clearance 48 and the bearing clearance of the bearing 12.

The impeller 22 may have a shroud 24. In the exemplary embodiments shown in FIGS. 1A to 1E, the impeller 22 is a closed impeller and includes a shroud 24 covering the blades 23.

In other embodiments, the impeller 22 is an open impeller with no shroud covering the blades 23.

The magnet 26 is a permanent magnet arranged facing the stator 40. In the embodiments shown in FIGS. 1A to 1E, the electric pump 1 (1A to 1E) is an SPM motor in which the magnet 26 (permanent magnet) is exposed on the surface of the rotor 20 facing the stator 40.

A single magnet 26 may be used for the electric pump 1 (1A to 1E), or a plurality of split magnets 26 may be used. The shape of the magnet 26 can be freely selected according to the shape of the stator 40, for example, it can be cylindrical, arc-shaped, disk-shaped, or bar-shaped.

In some embodiments, as shown in FIGS. 1A to 1E, the rotor 20 further includes, in addition to the impeller 22 and the magnet 26 in the above configuration, a magnet holding part 21 integrally formed with at least the magnet 26.

In the embodiments shown in FIGS. 1A to 1D, the magnet holding part 21 is located on the opposite side of the impeller 22 from the fluid inlet 3 with respect to the axial direction and holds the magnet 26 so as to face the stator 40.

The magnet holding part 21 may be formed by a resin material. In this case, the rotor 20 can be formed by insert molding. Specifically, the rotor 20 in which at least the magnet 26 and the magnet holding part 21 are integrally formed can be obtained by insert molding with the magnet 26 as an insert part.

In other embodiments, the magnet holding part 21 is formed by a rotor core (not shown) composed of laminated electromagnetic steel sheets.

As shown in FIGS. 1A to 1E, the stator 40 is a stationary member disposed facing the rotor 20 in the above configuration, and includes a stator core 42, a stator coil 44, and a molding material 46.

The stator core 42 forms a magnetic path through which a magnetic flux generated by energizing the stator coil 44 flows. The stator core 42 is spaced from the magnet 26 of the rotor 20 with a magnetic gap G. The magnetic gap G is formed over the region where the stator core 42 and the magnet 26 face each other. The stator 40 faces the rotor 20 in a non-contact manner with a clearance 48 therebetween within the region where the magnetic gap G is formed. In the embodiments shown in FIGS. 1A, 1B, 1D, and 1E, the magnetic gap G is a radial magnetic gap extending in an annular shape along the axial direction of the rotor 20. In contrast, in the embodiment shown in FIG. 1C, the magnetic gap G is an axial magnetic gap extending in a disk shape along the radial direction of the rotor.

In the electric pump 1 (1A, 1D, 1E) of inner rotor type shown in FIGS. 1A, 1D and 1E, the magnet 26 is located radially inward of the stator core 42 so as to form the radial magnetic gap G between the magnet 26 and the stator core 42.

In the electric pump 1 (1B) of outer rotor type shown in FIG. 1B, the magnet 26 is located radially outward of the stator core 42 so as to form the radial magnetic gap G between the magnet 26 and the stator core 42.

In the electric pump 1 (1C) of axial gap type shown in FIG. 1C, the magnet 26 is located on the back side of the impeller 22 so as to form the axial magnetic gap G between the magnet 26 and the stator core 42.

The stator core 42 is wound with the stator coil 44.

The stator coil 44 may be wound around the teeth of the stator core 42 and received in a slot formed in the stator core 42.

The stator core 42 and the stator coil 44 are covered by the molding material 46 made of resin. In other words, the stator core 42 and the stator coil 44 are embedded in the molding material 46.

The stator 40 in which the stator core 42 and the stator coil 44 are covered by the resin molding material 46 can be obtained by insert molding. Specifically, the stator 40 in which the stator core 42 and the stator coil 44 are embedded in the molding material 46 can be obtained by setting the stator core 42 and the stator coil 44 in a mold as insert parts, and injecting resin into the mold.

Electricity to be supplied to the stator coil 44 of the stator 40 in the above configuration is controlled by the control board 70 disposed in the board chamber 110.

The control board 70 includes a printed wiring board 72, and an electronic component 74 mounted on the printed wiring board 72. The electronic component 74 includes, for example, switching devices such as MOSFETs and IGBTs, and passive components such as capacitors, resistors, and coils.

One or more electronic components 74 are mounted on the surface of the printed wiring board 72 facing the heat sink 80. One or more electronic components 74 may be mounted on the surface of the printed wiring board 72 away from the heat sink 80.

In some embodiments, as shown in FIGS. 1A to 1E, the interior space of the casing 2 is divided by the partition part 50 of the casing 2 into the board chamber 110 for accommodating the control board 70 and the pump motor chamber 100 for accommodating the rotor 20 and the stator 40. The partition part 50 of the casing 2 separates the pump motor chamber 100, which is filled with fluid, from the board chamber 110, where no fluid is present. The partition part 50 of the casing 2 partially defines the pump motor chamber 100 and the board chamber 110.

In the embodiment shown in FIGS. 1A to 1E, the partition part 50 of the casing 2 is located between the pump motor chamber 100 and the board chamber 110 in the axial direction. The partition part 50 has a first wall surface 52 adjacent to the pump motor chamber 100 and a second wall surface 54 adjacent to the board chamber 110. The first wall surface 52 of the partition part 50 at least partially forms the bottom surface of the pump motor chamber 100. The second wall surface 54 of the partition part 50 at least partially forms the top surface of the board chamber 110.

The partition part 50 of the casing 2 is integrally formed with the support part 10 and the stator 40. Specifically, the partition part 50 is formed as part of the resin molding material 46 by integral molding with the stator core 42, the stator coil 44, and the support part 10 as insert parts.

The partition part 50 integral with the support part 10 and the stator 40 can be obtained by injecting resin into a mold with the stator core 42 and the stator coil 44 set in the mold as insert parts. The partition part 50 may be part of the molding material 46 that constitutes the intermediate casing 2A.

In some embodiments, as shown in FIGS. 1A to 1E, the partition part 50 is formed integrally with the stationary shaft 11 as the support part 10 and the stator 40. In other embodiments, the partition part 50 is formed integrally with the bearing as the support part 10 and the stator 40.

In the embodiments shown in FIGS. 1A to 1E, an end portion 14 of the stationary shaft 11 as the support part 10 on the side opposite to the impeller 22 in the axial direction is embedded in part of the molding material 46 that constitutes the partition part 50 (a portion of the molding material 46 that constitutes the partition part 50).

In other embodiments, an end portion 14 of the bearing as the support part 10 on the side opposite to the impeller 22 in the axial direction is embedded in part of the molding material 46 that constitutes the partition part 50 (a portion of the molding material 46 that constitutes the partition part 50).

In some embodiments, as shown in FIGS. 1A to 1E, the partition part 50 has one or more openings 60 allowing fluid from the impeller 22 to pass through. The partition part 50 may have a plurality of openings 60.

Each opening 60 communicates with the discharge port 22B of the impeller 22, and the fluid from the impeller 22 can flow through the pump motor chamber 100 and pass through the openings 60.

The shape of each opening 60 is not limited, but may be any shape. Each opening 60 may have a circular or non-circular shape, such as ellipse, track shape, fan shape, rectangle, square, etc.

In the embodiment shown in FIGS. 1A, 1D and 1E, the openings 60 in the partition part 50 are located downstream of the clearance 48 between the rotor 20 and the stator 40 with respect to the flow direction of fluid in the pump motor chamber 100. In this case, the fluid from the impeller 22 passes through the clearance 48 between the rotor 20 and the stator 40 and then through the openings 60 in the partition part 50.

In contrast, in the embodiment shown in FIGS. 1B and 1C, the openings 60 in the partition part 50 are parallel to the clearance 48 between the rotor 20 and the stator 40 with respect to the flow direction of fluid in the pump motor chamber 100. In this case, the fluid from the impeller 22 is diverted upstream of the clearance 48 between the rotor 20 and the stator 40 and the openings 60 in the partition part 50, and part of the fluid passes through the openings 60 in the partition part 50.

Each opening 60 is provided through the partition part 50 and has a first opening end 61 that opens to the first wall surface 52 of the partition part 50 adjacent to the pump motor chamber 100 and a second opening end 62 that is opposite the first opening end 61.

In the exemplary embodiments shown in FIGS. 1A to 1E, the openings 60 in the partition part 50 are disposed around the end portion 14 of the stationary shaft 11 as the support part 10 on the side opposite to the impeller 22. In this case, the first opening end 61 of each opening 60 is located within the extension range of the end portion 14 of the stationary shaft 11 in the axial direction. In other words, the end portion 14 of the stationary shaft 11 extends beyond the first opening end 61 of each opening 60 to the opposite side from the impeller 22 in the axial direction.

As illustrated in FIGS. 1A to 1E, the second opening end 62 of each opening 60 may be located within the extension range of the end portion 14 of the stationary shaft 11. In other words, the end portion 14 of the stationary shaft 11 may extend beyond the second opening end 62 of each opening 60 to the opposite side from the impeller 22 in the axial direction.

As shown in FIGS. 1A to 1E, the one or more openings 60 in the partition part 50 are closed by the heat sink 80 to promote heat dissipation from the control board 70. The heat sink 80 prevents fluid having passed through the openings 60 from entering the board chamber 110.

In the embodiments shown in FIGS. 1A to 1E, the heat sink 80 is arranged facing the partition part 50 in the axial direction so that a chamber 64 is formed between the heat sink 80 and the partition part 50. The chamber 64 is a space which communicates with the one or more openings 60 in the partition part 50 and into which the fluid can flow. The heat sink 80 is disposed in the board chamber 110 and defines the chamber 64 together with the partition part 50.

In this case, the fluid passing through the openings 60 flows into the chamber 64 to cool the heat sink 80. The fluid can enter and exit the chamber 64 through the openings 60, and the fluid in the chamber 64 is discharged through any of the openings 60. Thus, the fluid in the chamber 64 is replaced by the fluid entering and exiting through the openings 60, allowing the heat sink 80 to be cooled efficiently.

In the case where the partition part 50 has a plurality of openings 60, as shown in FIGS. 1A to 1E, the chamber 64 may be a single common chamber communicating with all the openings 60. Alternatively, a plurality of chambers 64, independent of each other, may each communicate with at least one corresponding opening 60.

In the exemplary embodiments shown in FIGS. 1B and 1C, the chamber 64 communicates with the interior space 13 of the hollow support part 10 (stationary shaft 11) via a communication hole 51 in the partition part 50.

The fluid passing through the openings 60 in the partition part 50 flows through the chamber 64 and is then returned to the intake port 22A of the impeller 22 through the communication hole 51 and the interior space 13 of the support part 10. In this case, the fluid in the chamber 64 can be effectively replaced, which enhances the cooling effect of the heat sink 80 by the fluid.

The heat sink 80 is composed of a material with higher thermal conductivity than the molding material 46.

The material of the heat sink 80 is not limited, and examples thereof include metal materials such as copper, aluminum, and alloys containing them, resin compositions such as PPS resin, PA6 resin, and PEEK resin, and composite materials such as matrix resin with carbon fiber or graphite powder. Resin compositions such as PPS resin, PA6 resin, and PEEK resin may contain fillers.

In the embodiments shown in FIGS. 1A to 1E, the heat sink 80 is a plate part whose thickness t is sufficiently smaller than the dimensions in other directions. Specifically, the dimension (plate thickness t) of the heat sink 80 along the axial direction of the electric pump 1 (1A to 1E) is less than one-third of the dimension (plate width) of the heat sink 80 along the radial direction of the electric pump 1 (1A to 1E), for example not more than one-tenth. In other embodiments, the dimension (plate thickness t) of the heat sink 80 along the axial direction of the electric pump 1 (1A to 1E) is not less than one-third of the dimension (plate width) of the heat sink 80 along the radial direction of the electric pump 1 (1A to 1E).

The shape of the heat sink 80 is not limited and may be any shape, including cup, hat, and flat plate.

In the embodiments shown in FIGS. 1A to 1C and 1E, the heat sink 80 has a hat shape with a recess 82. In this case, the partition part 50 of the casing 2 has an annular projection 56 protruding toward the board chamber 110 so as to surround the one or more openings 60, and the recess 82 of the heat sink 80 engages the annular projection 56 of the partition part 50.

In contrast, in the embodiment shown in FIG. 1D, the heat sink 80 has a flat plate shape.

In the embodiment shown in FIG. 1E, the heat sink 80 has a plurality of projections 84 formed on the surface facing the partition part 50 in order to expand the heat transfer area. In this case, each projection 84 protrudes toward the partition part 50 so as to penetrate into the chamber 64 between the heat sink 80 and the partition part 50.

In other embodiments, as shown in FIGS. 1A to 1D, the surface of the heat sink 80 facing the partition part 50 is a flat surface. In this case, the surface (flat surface) of the heat sink 80 facing the partition part 50 defines the chamber 64 between the heat sink 80 and the partition part 50.

The heat sink 80 may be provided in direct contact with the electronic component 74 of the control board 70 to promote heat dissipation from the electronic component 74.

Alternatively, as shown in FIGS. 1A to 1E, the electric pump 1 (1A to 1E) may further include a heat dissipation material 76 disposed between the electronic component 74 and the heat sink 80. As the heat dissipation material 76, for example, a heat dissipation grease can be used. When the heat dissipation material 76 is used, the heat sink 80 is at least partially non-contact with the electronic component 74, and the gap between the heat sink 80 and the electronic component 74 may be filled with the heat dissipation material 76.

In some embodiments, as shown in FIGS. 1A to 1E, the electric pump 1 (1A to 1E) includes a sealing member 90 disposed between the heat sink 80 and the partition part 50. The sealing member 90 is disposed annularly around the one or more openings 60 in the partition part 50. The heat sink 80 is fastened to the partition part 50 by a screw 81 on the radially outer side of the sealing member 90. In other embodiments, the heat sink 80 is fixed to the partition part 50 by welding on the radially outer side of the sealing member 90.

In the embodiments shown in FIGS. 1A to 1E, the sealing member 90 is attached to a circumferentially continuous annular groove 91 in the second wall surface 54 of the partition part 50 adjacent to the board chamber 110. In other embodiments not shown, the sealing member 90 is attached to an annular groove in the heat sink 80.

The sealing member 90 is not limited in configuration as long as it can seal the gap between the heat sink 80 and the partition part 50, and a sealing member of any configuration can be used. The sealing member 90 may be, for example, a sealing ring with any cross-sectional shape, such as an O-ring or X-ring. In the exemplary embodiments shown in FIGS. 1A to 1E, the sealing member 90 is an O-ring.

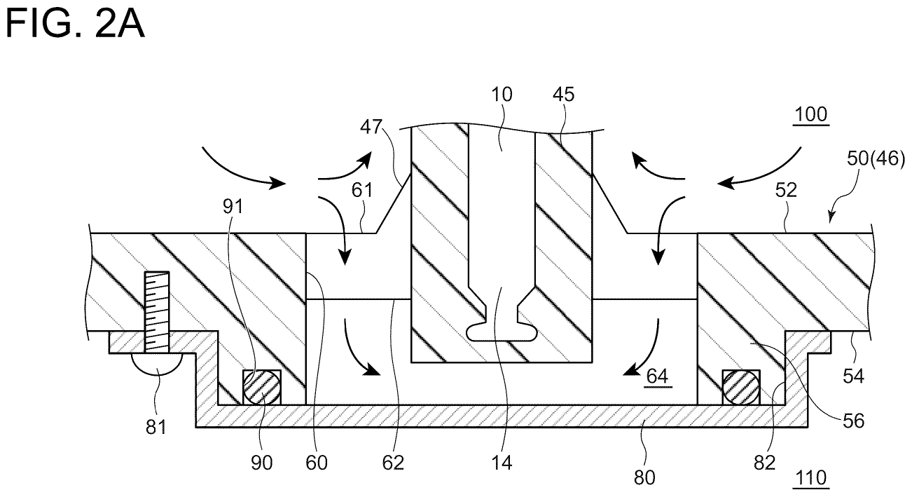

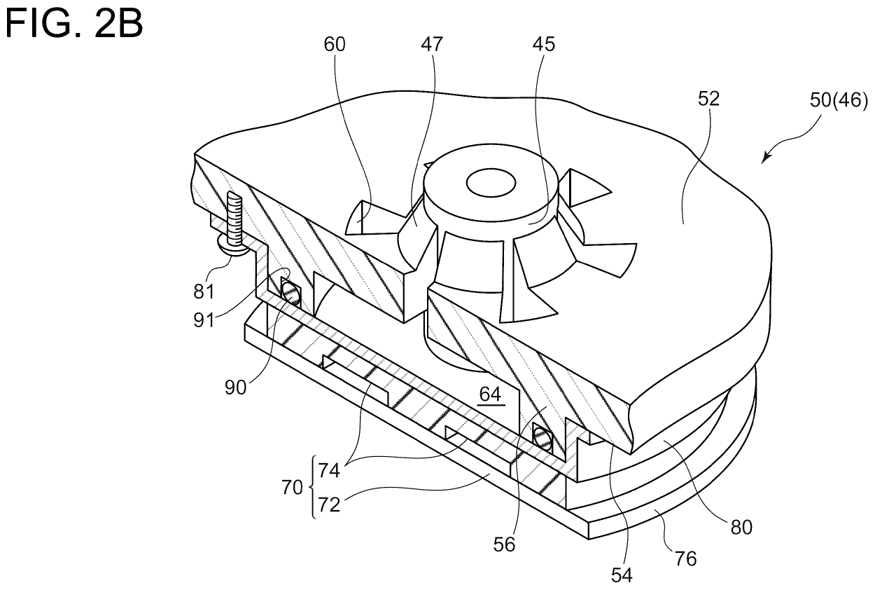

A specific configuration of the partition part 50 and the heat sink 80 will now be described with reference to FIGS. 2A to 4.

FIG. 2A is a schematic cross-sectional view showing a structure around the partition part 50 and the heat sink 80 according to an embodiment. FIG. 2B is a partial cross-sectional view corresponding to FIG. 2A, showing the structure around the partition part 50 and the heat sink 80.

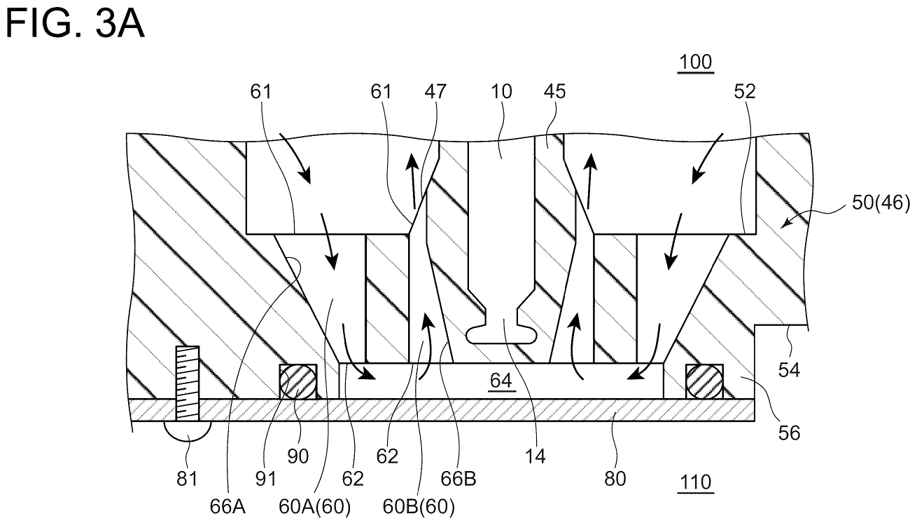

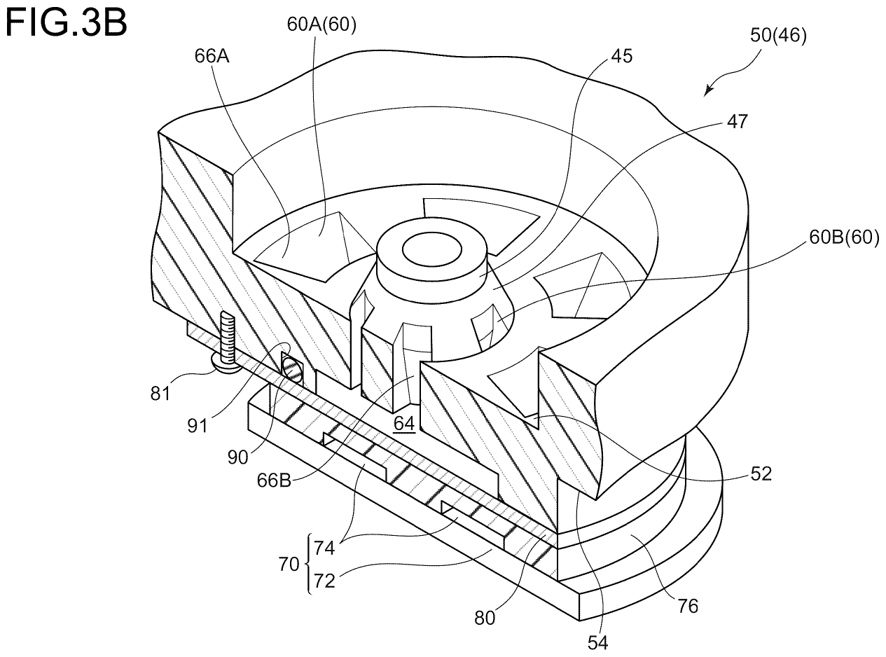

FIG. 3A is a schematic cross-sectional view showing a structure around the partition part 50 and the heat sink 80 according to another embodiment. FIG. 3B is a partial cross-sectional view corresponding to FIG. 3A, showing the structure around the partition part 50 and the heat sink 80.

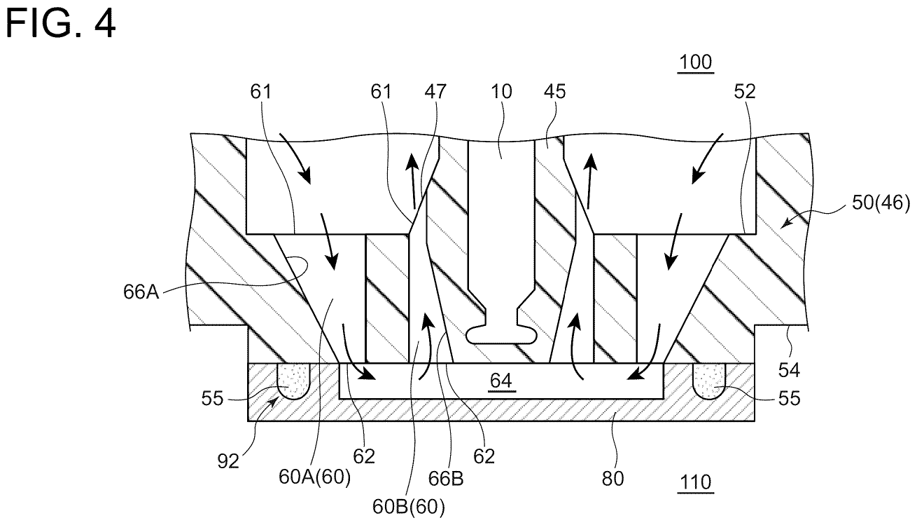

FIG. 4 is a schematic cross-sectional view showing a structure around the partition part 50 and the heat sink 80 according to still another embodiment.

For any of the above-described electric pumps 1 (1A to 1E), the configuration of the partition part 50 and the heat sink 80 described below with reference to FIGS. 2A to 4 can be adopted instead of the configuration of the partition part 50 and the heat sink 80 shown in FIGS. 1A to 1E.

In some embodiments, as shown in FIGS. 2A to 4, the partition part 50 has a plurality of openings 60 arranged in the circumferential direction. The plurality of openings 60 is formed in the partition part 50 so as to be arranged in the circumferential direction around the end portion 14 of the support part 10 opposite the impeller 22 in the axial direction. Each opening 60 communicates with a chamber 64 formed between the partition part 50 and the heat sink 80.

In the embodiment shown in FIGS. 2A and 2B, six openings 60 are formed in the partition part 50 at equal circumferential intervals.

In the embodiment shown in FIGS. 3A and 3B, six openings 60A are formed at equal circumferential intervals, and six openings 60B are formed at equal circumferential intervals in the partition part 50.

In some embodiments, as shown in FIGS. 3A to 4, the partition part 50 includes a plurality of first openings 60A arranged in the circumferential direction, and a plurality of second openings 60B disposed radially inward of the plurality of first openings 60A and arranged in the circumferential direction. The plurality of first openings 60A and the plurality of second openings 60B communicate with a chamber 64 formed between the heat sink 80 and the partition part 50.

In the exemplary embodiments shown in FIGS. 3A to 4, the radially outer boundary of the first opening 60A is defined by a tapered surface 66A that slopes radially inward as it approaches the chamber 64 in the axial direction of the electric pump 1. Accordingly, when the fluid after passing through the impeller 22 passes through the first openings 60A, the fluid flows into the chamber 64 while being deflected radially inward by the tapered surface 66A and is effectively directed to the second openings 60B, which is located radially inward of the first openings 60A. On the other hand, the radially inner boundary of the second opening 60B is defined by a tapered surface 66B that slopes radially inward as it approaches the chamber 64 in the axial direction of the electric pump 1. Accordingly, the tapered surface 66B guides the fluid flowing radially inward in the chamber 64 in a direction away from the chamber 64 in the axial direction, thereby facilitating the discharge of the fluid from the chamber 64 through the second openings 60B.

In some embodiments, as shown in FIGS. 2A to 4, the partition part 50 includes a cylindrical part 45 of substantially cylindrical shape into which the end portion 14 of the support part 10 opposite the impeller 22 is embedded, and the plurality of openings 60 is arranged in the circumferential direction so as to surround the cylindrical part 45. The partition part 50 has a tapered surface 47 connecting the first wall surface 52 adjacent to the pump motor chamber 100 to the outer peripheral surface of the cylindrical part 45. The tapered surface 47 slopes radially inward with increasing distance from the chamber 64 in the axial direction.

Fluid that does not pass through the openings 60 flows radially inward along the first wall surface 52 of the partition part 50 adjacent to the pump motor chamber 100 and is then redirected axially by the tapered surface 47 and returned toward the impeller 22, for example, through the bearing clearance of the bearing 12.

In the embodiment shown in FIGS. 2A and 2B, the cylindrical part 45 protrudes axially toward the heat sink 80 beyond the second opening end 62 of each opening 60 and penetrates into the chamber 64.

In the embodiments shown in FIGS. 3A to 4, the cylindrical part 45 extends axially to the same axial position as the second opening end 62 of each opening 60.

In some embodiments, as shown in FIG. 4, the partition part 50 has a welding portion 55 welded to the heat sink 80. The welding portion 55 is formed annularly so as to surround the plurality of openings 60.

It is sufficient that the welding portion 55 is liquid-tight to prevent fluid from entering the board chamber 110, and the formation of the welding portion 55 is not limited to a specific method. The welding portion 55 can be formed by, for example, hot plate welding, vibration welding, ultrasonic welding, infrared welding, laser welding, spin welding, etc.

In the exemplary embodiment shown in FIGS. 2A and 2B, the heat sink 80 of hat shape is fastened to the partition part 50 by a screw 81 with an annular projection 56 of the partition part 50 fitting into a recess 82 of the heat sink 80. The protruding end of the annular projection 56 has an annular groove 91 continuous in the circumferential direction, and an annular sealing member 90 is placed in the annular groove 91. The annular sealing member 90 surrounds the plurality of openings 60 in the partition part 50. The position where the heat sink 80 is fastened to the partition part 50 by the screw 81 is radially outward of the annular sealing member 90.

In the exemplary embodiment shown in FIGS. 3A and 3B, an annular sealing member 90 for sealing the gap between the heat sink 80 of flat plate shape and the partition part 50 is placed in an annular groove 91 in the second wall surface 54 of the partition part 50 adjacent to the board chamber 110. The heat sink 80 of flat plate shape is fastened to the partition part 50 by means of a screw 81. The annular sealing member 90 surrounds the plurality of openings 60 (60A, 60B) in the partition part 50. The position where the heat sink 80 is fastened to the partition part 50 by the screw 81 is radially outward of the annular sealing member 90.

In the exemplary embodiment shown in FIG. 4, the heat sink 80 of substantially flat plate shape is welded to the partition part 50 at an annular welding portion 55 in the partition part 50. The annular welding portion 55 surrounds the plurality of openings 60 (60A, 60B).

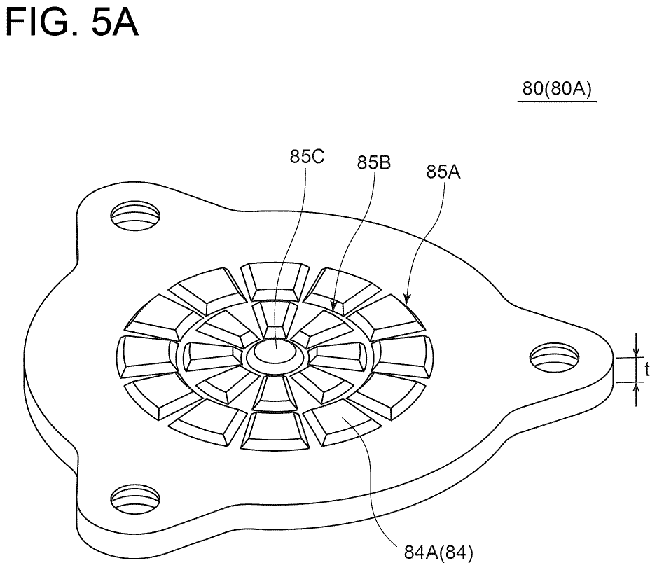

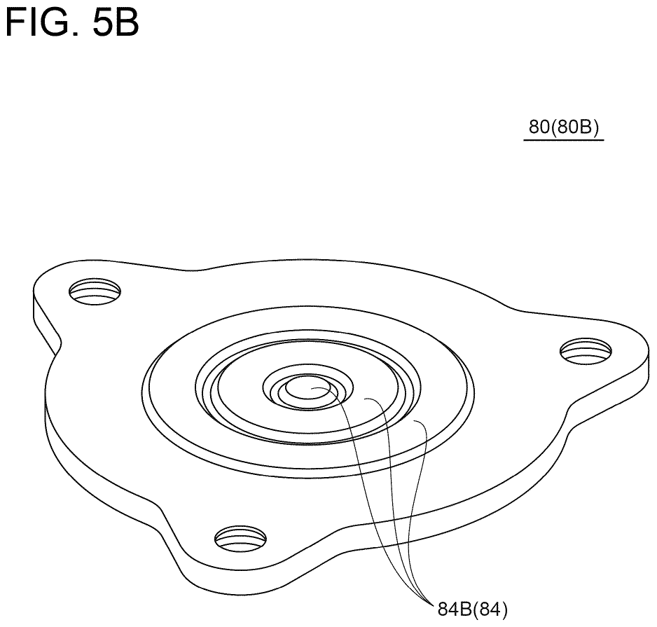

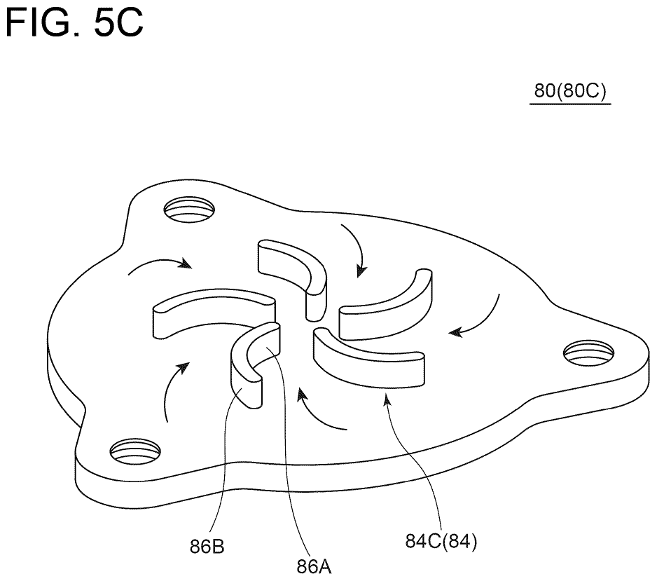

A specific configuration of the projection 84 of the heat sink 80 will now be described with reference to FIGS. 5A to 5C.

FIG. 5A is a perspective view showing a structure of a heat sink according to an embodiment. FIG. 5B is a perspective view showing a structure of a heat sink according to another embodiment. FIG. 5C is a perspective view showing a structure of a heat sink according to still another embodiment.

For any of the above-described electric pumps 1 (1A to 1E), the configuration of the heat sink 80 described below with reference to FIGS. 5A to 5C can be adopted instead of the configuration of the heat sink 80 shown in FIGS. 1A to 1E. In the exemplary embodiments shown in FIGS. 5A to 5C, the heat sink 80 (80A to 80C) has a substantially disk shape, but in other embodiments, the heat sink 80 may be polygonal, such as square or rectangular, or may be elliptical or track-shaped.

In the embodiments shown in FIGS. 5A to 5C, the heat sink 80 (80A to 80C) has a plurality of projections 84 (84A to 84C) formed on a surface facing the partition part 50.

The method of forming the projections 84 is not limited, and the projections 84 may be formed by embossing or die casting, for example.

The protruding height of the projections 84 is not limited, but in the case where the projections 84 are formed by embossing, the ratio of the protruding height of the projections 84 to the plate thickness t may be between 0.1 and 0.5. In the case where the projections 84 are formed by die casting, the ratio of the protruding height of the projections 84 to the plate thickness t may be between 0.2 and 1.

In the exemplary embodiment shown in FIG. 5A, the heat sink 80A includes a plurality of projections 84A arranged in the circumferential direction.

Each projection 84A belongs to one of the projection rows 85 (85A to 85C) located at different radial positions. The number of projections 84A belonging to the outermost projection row 85A (twelve) is greater than the number of projections 84A belonging to the projection row 85B located inward of the projection row 85A (eight). The array pitch (angle) of the projections 84A in the circumferential direction differs between the projection rows 85A and 85B. The innermost projection row 85C includes one projection 84A.

In the exemplary embodiment shown in FIG. 5B, the heat sink 80B includes a plurality of projections 84B each of which extends continuously in the circumferential direction.

The projections 84B are provided at different radial positions. The outermost projection 84B and the projection 84B located inward thereof are annular projections continuous in the circumferential direction. The innermost projection 84B is a circular projection continuous in the circumferential direction.

In the exemplary embodiment shown in FIG. 5C, the heat sink 80C includes a plurality of vanes 84C curved radially inward as the projections 84. The vanes 84C are curved in the same direction. Each vane 84C has a concave curved surface 86A and a convex curved surface 86B.

The direction of curvature of each vane 84C may be set according to the direction of rotation of the rotor 20 in the electric pump 1. The fluid passing through the openings 60 in the partition part 50 may enter the chamber 64 while maintaining a swirl component along the direction of rotation of the rotor 20 and flow in the direction of arrow in FIG. 5C. The fluid with a swirling component flows along the concave curved surfaces 86A of the vanes 84C.

The characteristic configurations of the electric pump 1 (1A to 1E) according to some embodiments described above are summarized as follows.

[1] An electric pump (1; 1A to 1E) according to at least some embodiments of the present invention is provided with: a support part (10); a rotor (20) that includes an impeller (22) and a magnet (26) and is rotatably supported by the support part (10); a stator (40) that includes a stator core (42) disposed with a magnetic gap (G) between the stator core (42) and the magnet (26), a stator coil (44) wound around the stator core (42), and a molding material (46) covering the stator core (42) and the stator coil (44); a control board (70) for controlling electricity to be supplied to the stator coil (44); and a casing (2) that partially defines a pump motor chamber (100) for accommodating the rotor (20) and the stator (40) and a board chamber (110) for accommodating the control board (70) and includes a partition part (50) separating the pump motor chamber (100) from the board chamber (110). The partition part (50) of the casing (2) is formed as part of the molding material (46) by integral molding with the stator core (42), the stator coil (44), and the support part (10) as insert parts, and has one or more openings (60) allowing a fluid from the impeller (22) to pass through. The electric pump (1; 1A to 1E) is further provided with a heat sink (80) disposed to close the one or more openings (60) of the partition part (50).

With the above configuration [1], the fluid passing through the openings (60) in the partition part (50) of the casing (2), which separates the pump motor chamber (100) from the board chamber (110), flows toward the heat sink (80) that closes the openings (60), thus promoting heat dissipation from the control board (70) via the heat sink (80).

Additionally, since the partition part (50) with the openings (60) for guiding the fluid to the heat sink (80) is formed as part of the molding material (46) by integral molding with the stator core (42), the stator coil (44), and the support part (10) as insert parts, the number of parts and assembly man-hours can be reduced.

Therefore, it is possible to reduce the number of parts and assembly man-hours while promoting heat dissipation from the control board (70).

[2] In some embodiments, in the above configuration [1], the heat sink (80) is arranged facing the partition part (50) in the board chamber (110) so that a chamber (64) communicating with the one or more openings (60) is formed between the heat sink (80) and the partition part (50).

With the above configuration [2], the fluid flowing into the chamber (64) through the openings (60) in the partition part (50) cools the heat sink (80) facing the chamber (64) and promotes heat dissipation from the control board (70) more effectively.

[3] In some embodiments, in the above configuration [1] or [2], the heat sink (80) is a plate part with a higher thermal conductivity than the molding material (46).

With the above configuration [3], since the heat sink (80) has a higher thermal conductivity than the molding material (46), heat dissipation from the control board (70) is promoted more effectively.

Further, as described in [1], the support part (10) is formed integrally with the molding material (46) that constitutes the partition part (50). Therefore, the heat sink (80) does not need a function to support the support part (10), but can adopt the form of a plate part that prioritizes the promotion of heat dissipation. The heat sink (80) composed of a plate part promotes heat dissipation from the control board (70) more effectively due to the small dimension (thickness) of the heat sink (80) in the heat dissipation path from the control board (70) to the fluid.

[4] In some embodiments, in any of the above configurations [1] to [3], the electric pump (1; 1A to 1E) is provided with a sealing member (90) disposed annularly so as to surround the one or more openings (60) between the heat sink (80) and the partition part (50).

With the above configuration [4], the sealing member (90) prevents the fluid passing through the one or more openings (60) from entering the board chamber (110), improving the reliability of the electric pump (1; 1A to 1E).

[5] In some embodiments, in any of the above configurations [1] to [3], the partition part (50) has a welded portion (55) welded to the heat sink (80). The welded portion (55) is formed annularly so as to surround the one or more openings (60).

With the above configuration [5], welding the partition part (50) and the heat sink (80) at the annular welding portion (55) prevents the fluid passing through the one or more openings (60) from entering the board chamber (110), improving the reliability of the electric pump (1).

[6] In some embodiments, in any of the above configurations [1] to [5], the partition part (50) has an annular projection (56) protruding toward the board chamber (110) so as to surround the one or more openings (60). The heat sink (80) has a recess (82) that engages the annular projection (56).

With the above configuration [6], by engaging the recess (82) of the heat sink (80) with the annular projection (56) of the partition part (50), the heat sink (80) can be placed closer to the control board (70), and heat dissipation from the control board (70) can be promoted more effectively.

[7] In some embodiments, in the above configuration [1] or [2], the one or more openings (60) include a plurality of openings (60) formed in the partition part (50) so as to be arranged in a circumferential direction.

With the above configuration [7], by cooling the heat sink (80) with fluid taken in from the plurality of openings (60) arranged in the circumferential direction, heat dissipation from the control board (70) can be promoted more effectively.

[8] In some embodiments, in the above configuration [7], an end portion (14) of the support part (10) on a side opposite to the impeller (22) in an axial direction is embedded in the part of the molding material (46) that constitutes the partition part (50). The plurality of openings (60) is formed in the part of the molding material (46) so as to be arranged in the circumferential direction around the end portion (14) of the support part (10).

With the above configuration [8], by arranging the plurality of openings (60) in the circumferential direction around the end portion (14) of the support part (10) embedded in the partition part (50; part of molding material 46), the fluid can be guided to the heat sink (80) while ensuring the length of the end portion (14) of the support part (10) embedded in the partition part (50).

Thus, heat dissipation from the control board (70) can be promoted while suppressing the increase in the axial dimension of the electric pump (1; 1A to 1E).

[9] In some embodiments, in any of the above configurations [1] to [8], the one or more openings (60) include: a plurality of first openings (60A) formed in the partition part (50) so as to be arranged in a circumferential direction; and a plurality of second openings (60B) formed radially inward of the plurality of first openings (60A) in the partition part (50) so as to be arranged in the circumferential direction. The plurality of first openings (60A) and the plurality of second openings (60B) communicate with a chamber (64) formed between the heat sink (80) and the partition part (50).

With the above configuration [9], since the partition part (50) has a plurality of first openings (60A) and a plurality of second openings (60B) formed at different radial positions, the fluid flow into and out of the chamber (64) between the heat sink (80) and the partition part (50) is promoted, and the effect of heat dissipation by the heat sink (80) can be improved.

[10] In some embodiments, in any of the above configurations [1] to [9], the control board (70) includes: a printed wiring board (72); and an electronic component (74) mounted on the printed wiring board (72). The electric pump (1; 1A to 1E) is further provided with a heat dissipation material (76) disposed between the electronic component (74) and the heat sink (80).

With the above configuration [10], the heat dissipation material (76) between the heat sink (80) and the electronic component (74) promotes heat dissipation from the electronic component (74).

[11] In some embodiments, in any of the above configurations [1] to [10], the heat sink (80) has a plurality of projections (84; 84A to 84C) formed on a surface facing the partition part (50).

With the above configuration [11], the plurality of projections (84; 84A to 84C) on the surface of the heat sink (80) facing the partition part (50) provides a heat dissipation promotion effect due to the increased heat transfer area of the heat sink (80).

[12] In some embodiments, in any of the above configurations [1] to [11], the casing (2) includes: an intermediate casing (2A) formed by the molding material (46); a pump casing (2B) attached to one end portion of the intermediate casing (2A) in an axial direction and covering the impeller (22) together with the intermediate casing (2A); and a board casing (2C) attached to the other end portion of the intermediate casing (2A) in the axial direction and covering the control board (70) together with the intermediate casing (2A).

With the above configuration [12], the number of parts can be reduced by forming the intermediate casing (2A), a component of the casing (2), with the molding material (46) that constitutes the partition part (50) having the openings (60) for guiding fluid to the heat sink (80).

[13] In some embodiments, in any of the above configurations [1] to [12], the magnet (26) is located radially inward of the stator core (42) so as to form the magnetic gap (G) between the magnet (26) and the stator core (42) in a radial direction.

With the above configuration [13], in an electric pump of inner rotor type (1; 1A, 1D, 1E) in which the rotor (20) including the magnet (26) is located radially inward of the stator (40), it is possible to promote heat dissipation from the control board (70) and reduce the number of parts and assembly man-hours, as described in [1].

[14] In some embodiments, in any of the above configurations [1] to [12], the magnet (26) is located radially outward of the stator core (42) so as to form the magnetic gap (G) between the magnet (26) and the stator core (42) in a radial direction.

With the above configuration [14], in an electric pump of outer rotor type (1; 1B) in which the rotor (20) including the magnet (26) is located radially outward of the stator (40), it is possible to promote heat dissipation from the control board (70) and reduce the number of parts and assembly man-hours, as described in [1].

[15] In some embodiments, in any of the above configurations [1] to [12], the magnet (26) is located on a back side of the impeller (22) so as to form the magnetic gap (G) between the magnet (26) and the stator core (42) in an axial direction.

With the above configuration [15], in an electric pump of axial gap type (1; 1C) in which the rotor (20) including the magnet (26) faces the stator (40) in the axial direction, it is possible to promote heat dissipation from the control board (70) and reduce the number of parts and assembly man-hours, as described in [1].

1. An electric pump, comprising:
a support part;
a rotor that includes an impeller and a magnet and is rotatably supported by the support part;
a stator that includes a stator core disposed with a magnetic gap between the stator core and the magnet, a stator coil wound around the stator core, and a molding material covering the stator core and the stator coil;
a control board for controlling electricity to be supplied to the stator coil; and
a casing that partially defines a pump motor chamber for accommodating the rotor and the stator and a board chamber for accommodating the control board and includes a partition part separating the pump motor chamber from the board chamber,
the partition part of the casing being formed as part of the molding material by integral molding with the stator core, the stator coil, and the support part as insert parts,
the partition part of the casing having one or more openings allowing a fluid from the impeller to pass through,
the electric pump further comprising a heat sink disposed to close the one or more openings of the partition part.

2. The electric pump according to claim 1, wherein
the heat sink is arranged facing the partition part in the board chamber so that a chamber communicating with the one or more openings is formed between the heat sink and the partition part.

3. The electric pump according to claim 1, wherein
the heat sink is a plate part with a higher thermal conductivity than the molding material.

4. The electric pump according to claim 1, comprising a sealing member disposed annularly so as to surround the one or more openings between the heat sink and the partition part.

5. The electric pump according to claim 1, wherein
the partition part has a welded portion welded to the heat sink, and
the welded portion is formed annularly so as to surround the one or more openings.

6. The electric pump according to claim 1, wherein
the partition part has an annular projection protruding toward the board chamber so as to surround the one or more openings, and
the heat sink has a recess that engages the annular projection.

7. The electric pump according to claim 1, wherein
the one or more openings include a plurality of openings formed in the partition so as to be arranged in a circumferential direction.

8. The electric pump according to claim 7, wherein
an end portion of the support part on a side opposite to the impeller in an axial direction is embedded in the part of the molding material that constitutes the partition part, and
the plurality of openings is formed in the part of the molding material so as to b arranged in the circumferential direction around the end portion of the support part.

9. The electric pump according to claim 1, wherein
the one or more openings include:
a plurality of first openings formed in the partition part so as to be arranged in a circumferential direction; and
a plurality of second openings formed radially inward of the plurality of first openings in the partition part so as to be arranged in the circumferential direction, and
the plurality of first openings and the plurality of second openings communicate with a chamber formed between the heat sink and the partition part.

10. The electric pump according to claim 1, wherein
the control board includes:
a printed wiring board; and
an electronic component mounted on the printed wiring board, and
the electric pump further comprises a heat dissipation material disposed between th electronic component and the heat sink.

11. The electric pump according to claim 1, wherein
the heat sink has a plurality of projections formed on a surface facing the partition part.

12. The electric pump according to claim 1, wherein
the casing includes:
an intermediate casing formed by the molding material;
a pump casing attached to one end portion of the intermediate casing in an axial direction and covering the impeller together with the intermediate casing; and
a board casing attached to the other end portion of the intermediate casing i the axial direction and covering the control board together with the intermediate casing.

13. The electric pump according to claim 1, wherein
the magnet is located radially inward of the stator core so as to form the magnetic gap between the magnet and the stator core in a radial direction.

14. The electric pump according to claim 1, wherein
the magnet is located radially outward of the stator core so as to form the magnetic gap between the magnet and the stator core in a radial direction.

15. The electric pump according to claim 1, wherein
the magnet is located on a back side of the impeller so as to form the magnetic between the magnet and the stator core in an axial direction.
